(19) United States
(12) Patent Application Publication
(10) Pub. No.: US 2007/0196657 A1
(43) Pub. Date: Aug. 23, 2007

(54) Transparent polymer composites

(75) Inventor: Suhas Bhandarkar, Pleasanton, CA (US)

Correspondence Address: Michelle B. Lando;Cabot Corporation, Billerica Technical Center, 157 Concord Road, Billerica, MA, 01821-7001, US

(73) Assignee: Cabot Corporation, Boston, MA (US)

(21) Appl. No.: 11/640,075

(22) Filed: Dec. 15, 2006

Related U.S. Application Data
(60) Provisional application No. 60/750,454, filed on Dec. 15, 2005.

(51) Int. Cl. B32B 5/16; C08K 9/00

(52) U.S. Cl. 428/403; 428/404; 428/405; 523/200

(57) ABSTRACT

The invention provides a composite material comprising (a) a polymer precursor or polymer having a refractive index and (b) particles comprising (1) cores based on at least two metal oxides, wherein the cores comprise aggregates of primary particles, and (2) a surface-treating agent bonded to the cores. The difference between the refractive index of the polymer precursor or polymer and the refractive index of the particles is about 2% or less of the refractive index of the polymer precursor or polymer. The invention further provides processes for preparing such a composite material.

### CROSS-REFERENCE TO RELATED APPLICATIONS

This patent application claims the benefit of U.S. Provisional Patent Application No. 60/750,454, filed Dec. 15, 2005.

### FIELD OF THE INVENTION

The invention pertains to transparent polymer composites and processes for preparing the same.

### BACKGROUND OF THE INVENTION

The processability and mechanical properties of many transparent polymers render such materials useful in a wide variety of applications. However, in applications wherein components are subject to temperature variations, the relatively high coefficient of thermal expansion of many polymers presents difficulties in their practical application. For example, optical fabrications comprising transparent polymeric components in conjunction with other materials having lower coefficients of thermal expansion can suffer damage when subjected to wide temperature variations.

It has long been known that the addition of filler materials to polymeric materials can confer a reduction in the coefficient of thermal expansion of the resulting polymeric composites, as well as an increased glass transition temperature, a reduction of the amount of the polymer by weight in the composite, an increased tensile strength, an increased stiffness, an increased abrasion resistance, an increased dimensional stability, a reduced permeability to gases, solvents, and water-vapor, and the like. Numerous filler materials have been employed in the art, including inorganic materials such as clays, particulate glasses prepared from metal oxides, and metal oxide particles themselves. However, the incorporation of filler materials into polymeric composites comprising transparent polymers often degrades the transparency of the polymeric composite relative to the transparency of the polymer components alone.

Transparency relates to light transmission through a material. Light transmission depends on factors including the absorption of light by the material and light scattering by fillers and other additives. Light scattering is caused by discontinuities in refractive index between the filler and the material in which the filler is dispersed. In addition to differences in refractive index, the particle shape and size of the filler affects light scattering by the filler.

Numerous attempts have been made in the art to optimize light transmission through polymeric composites comprising particulate fillers. U.S. Pat. No. 5,618,872 discloses a polymeric or polymerizable system comprising an organic matrix and a filler comprising particles based on two or more metal oxides. The ratio of metal oxides in the particles determines the refractive index of the particles, thus allowing matching of the refractive index of the particles with that of the organic matrix by control of the ratio of metal oxides. The particles are described as spherical, nonporous, and monodisperse (e.g., having a narrow particle size distribution), and can be surface-modified by the attachment of various surface-treating agents thereto. The surface-treating agents can be capable of reaction with the organic matrix to covalently incorporate the particles into the matrix. U.S. Pat. No. 6,246,123 discloses a particular epoxy resin organic matrix phase having an inorganic filler comprising an alkali zinc borosilicate glass dispersed therein. The inorganic filler has a refractive index matching that of the matrix phase, and the inorganic filler can be surface-treated with an agent capable of reaction with the matrix phase so that, upon polymerization, the inorganic filler is covalently incorporated into the organic matrix.

However, preparation of monodisperse spherical particles for use as a filler material requires careful control of the preparation of the particles. In addition, there is a limit to the loading of monodisperse spherical particles that can be incorporated into a polymeric composite, and therefore a limit to the extent to which the properties of the polymeric composite can be altered. Thus, there remains a need in the art for novel polymeric composite materials, and for processes for their preparation.

The invention provides such a polymeric composite and a process for its preparation. These and other advantages of the invention, as well as additional inventive features, will be apparent from the description of the invention provided herein.

### BRIEF SUMMARY OF THE INVENTION

The invention provides a composite material comprising (a) a polymer precursor or polymer, wherein the polymer precursor or polymer has a first refractive index, and (b) particles comprising (1) cores having a surface comprising at least two oxides selected from the group consisting of silicon oxide, titanium oxide, aluminum oxide, cerium oxide, tantalum oxide, tin oxide, cesium oxide, and hafnium oxide, wherein the cores comprise aggregates of primary particles, and (2) a surface-treating agent bonded to the surface of the cores, wherein the particles have a second refractive index, wherein the difference between the first refractive index and the second refractive index is about 2% or less of the first refractive index.

The invention also provides a process for preparing a composite material, which process comprises (i) providing a polymer precursor or polymer, wherein the polymer precursor or polymer has a first refractive index, (ii) providing particles comprising (1) cores having a surface comprising at least two oxides selected from the group consisting of silicon oxide, titanium oxide, aluminum oxide, cerium oxide, tantalum oxide, tin oxide, cesium oxide, and hafnium oxide, wherein the cores comprise aggregates of primary particles, and (2) a surface-treating agent bonded to the surface of the cores, wherein the particles have a second refractive index, and wherein the difference between the first refractive index and the second refractive index is about 2% or less of the first refractive index, and (iii) combining the polymer precursor or polymer with the particles to provide a composite material.

### DETAILED DESCRIPTION OF THE INVENTION

The invention provides a composite material. The composite material comprises (a) a polymer precursor or polymer and (b) particles. The particles comprise (1) cores having a surface comprising at least two oxides selected from the group consisting of silicon oxide, titanium oxide, aluminum oxide, cerium oxide, tantalum oxide, tin oxide, cesium oxide, and hafnium oxide, wherein the cores comprise aggregates of primary particles, and (2) a surface-treating agent bonded to the surface of the cores. The polymer precursor or the polymer has a first refractive index, and the particles have a second refractive index. The difference between the first refractive index and the second refractive index is about 2% or less of the first refractive index.

The polymer can be any suitable polymer. The polymer desirably is transmissive to incident light irradiation at a desired wavelength or range of wavelengths. The polymer desirably allows a light transmission of about 85% or more (e.g., about 90% or more, or about 95% or more) of a beam of light directed to the composite material at a specular angle of less than about 5° and having a wavelength of about 400 nm, through a thickness of about 2 mm of the composite material. Typically, the polymer is amorphous and will not comprise any crystalline phase or phases that can contribute materially to the scattering of light. In general, the polymer will have a glass transition temperature that is above the highest temperature to which the polymer, when formulated into a composite material, will be subject to while in use.

The term “polymer precursor” as used herein refers to a material or mixture of materials that, upon reaction (e.g., polymerization), gives rise to the aforesaid polymer. Thus, the polymer will comprise units derived from the polymer precursor used to prepare the polymer. Examples of polymer precursors include but are not limited to monomeric units selected from the group consisting of acrylate monomers, methacrylate monomers, silicone monomers, a combination of an organic diol and a phosgene equivalent, and a combination of an organic diol and a diisocyanate.

Acrylate and methacrylate monomers are derivatives of acrylic acid and methacrylic acid, respectively, and have the general structure R—O—CO—C(R′)═CH₂, wherein R′ is hydrogen in the case of acrylate monomers, and R′ is methyl in the case of methacrylate monomers.

Silicone monomers refers to small molecules that, when polymerized, provide silicone polymers. Silicone polymers and methods of production thereof are well known in the art. Non-limiting examples of suitable silicone monomers include chlorosilanes, alkoxysilanes, linear oligosiloxanes, and cyclic oligosiloxanes. Preferably, the silicone polymers have a glass transition temperature of about room temperature (e.g., about 25° C.) or more.

Organic diols and phosgene equivalents in combination are monomers that react to form polycarbonates. Any suitable organic diol and any suitable phosgene equivalent as well as combinations thereof can be employed in the practice of the invention. Generally, the organic diols have the structure HO—R—OH, wherein R is a C₂-C₃₀ alkyl, aryl, alkylaryl, or arylalkyl group, and wherein each hydroxyl group (e.g., OH group) is bonded to a different carbon atom. Phosgene equivalents include phosgene, diphosgene, triphosgene, N,N′-carbonyldiamidazole, diphenyl carbonate, alkyl chloroformates, dialkyl carbonates, and dicyanocarbonyl. Diphosgene(trichloromethyl chloroformate) and triphosgene(trichloromethyl carbonate) are represented by the formulas ClC(O)CCl₃ and Cl₃COC(O)OCCl₃, respectively.

Organic diols and diisocyanates in combination are monomers that react to form polyurethanes. Any suitable diol and any suitable diisocyanate as well as combinations thereof can be employed in the practice of the invention. The organic diols can be as described herein. Generally, the diisocyanates have the structure O═C═N—R—N═C═O, wherein R is a C₂-C₃₀ alkyl, aryl, alkylaryl, or arylalkyl group, and wherein each isocyanate group (e.g., O═C═N— group) is bonded to a different carbon atom.

The polymer precursor can further comprise additional components including but not limited to polymerization initiators and chain terminators. Polymerization initiators include acids, bases, nucleophilic compounds such as amines and mercaptans, and free-radical sources such as peroxides and 2,2′-azobisisobutyronitrile. Chain terminators are compounds that react with a growing polymer chain to “cap” the chain and thereby control polymer chain length. The polymer precursor can further comprise any commonly used polymer additives, provided that the polymer additives do not substantially diminish light transmission through the polymer precursor and the polymer produced therefrom.

The particles comprise cores comprising at least two oxides selected from the group consisting of silicon oxide, titanium oxide, aluminum oxide, cerium oxide, tantalum oxide, tin oxide, cesium oxide, and hafnium oxide, wherein the cores comprise aggregates of primary particles. The cores can be prepared by any suitable method. Suitable methods for preparing the cores include pyrogenic processes and solution processes. In pyrogenic processes, which include fuming processes, a feedstock comprising a mixture of at least two volatilizable metal oxide precursors is vaporized and fed into a stream of a combustion gas to form a reaction mixture such that the liquid feedstock is atomized and subjected to a sufficient temperature and residence time in the combustion stream for fumed metal oxide particles (i.e., cores) to form before the combustion gas temperature is reduced below the solidifying temperature of the fumed metal oxide particles. Suitable metal oxide precursors include but are not limited to volatile metal compounds such as metal halides and metal alkoxides. When the cores comprise silicon, suitable silicon precursors include, but are not limited to, silicon halides, silicates (e.g., tetraethoxyorthosilicate), alkoxysilanes, silicones, silicone oils, siloxanes, silazanes, and the like. When the cores comprise titanium, suitable titanium precursors include, but are not limited to, titanium tetrachloride, titanium tetraisopropoxide, and the like. In an embodiment, the cores are prepared by the process disclosed in U.S. Patent Application Publication 2004/0156773 A1.

Cores formed by pyrogenic processes comprise aggregates of primary particles. Some metal oxide particles, such as fumed metal oxide particles and co-fumed particles comprising two or more metal oxides, comprise small primary particles that are fused together to form larger, chain-like aggregate particles. Considerable force is required to break these aggregate particles into primary particles so that, under normal conditions of use, the primary particles are present solely as aggregates and not as individual primary particles. For example, the aggregate particles do not break down under normal dispersion forces. This differentiates aggregate particles from agglomerate particles, which are formed by the relatively loose association of aggregate particles with one another. Typically, cores formed by pyrogenic processes do not have a spherical shape, but rather have irregular shapes due to the chain-like aggregation of the primary particles. Advantageously, cores formed by pyrogenic processes are capable of packing efficiently into a given volume because of their irregular shape and leaving less volume unoccupied by the cores, so that composite materials formed from pyrogenically formed cores can comprise a higher loading of the cores as compared to spherical cores (i.e., the composite materials can comprise a higher weight of the cores relative to the total weight of the composite material with use of pyrogenically formed cores as compared with substantially spherical cores).

Suitable solution processes for preparing the cores include sol-gel processes, precipitation processes, and hydrothermal processes. All of these processes generally involve the generation of metal oxide precursor species in solution via hydrolysis of at least two metal-containing compounds. Sol-gel processes generally involve the hydrolysis of suitable metal-containing precursors to form intermediate species containing metal-oxygen bonds, which species undergo further polymerization to form a gel. The gel can be dried and then mechanically processed to provide discrete mixed metal oxide particles. Precipitation processes generally involve the hydrolysis of suitable metal-containing precursors as in sol-gel processes, but under conditions that result in the direct production of mixed metal oxide particles, thereby avoiding the intermediacy of a gel. Hydrothermal processes useful in the context of the invention generally involve the reaction of at least two metal salts, such as metal nitrates and/or metal carbonates, with a base such as sodium hydroxide or potassium hydroxide, using water as a solvent, followed by heating of the resulting mixtures at elevated pressures that result in the production of the mixed metal oxide particles. Depending on the conditions utilized in solution processes, the particles produced can consist of primary particles or as aggregates of primary particles, as discussed in connection with pyrogenically produced cores. Under certain conditions, initially formed primary particles experience particle growth through reaction of metal-containing precursors at the surface of the primary particles and form substantially spherical cores. Under other conditions, initially formed primary particles join together through surface bonds and form aggregated cores comprising linked primary particles. For example, particles prepared by sol-gel processes are typically aggregates of primary particles. Preferably, cores prepared by solution processes that are useful in the context of the invention comprise aggregates of primary particles. Moreover, solution process cores comprising aggregates of primary particles have irregular, non-spherical shapes having advantages as discussed in connection with pyrogenically produced cores. Examples of metal oxide species useful in solution processes can be as set forth for pyrogenic processes.

Typically, pyrogenic processes and solution processes for the production of mixed metal oxide cores useful in the invention result in the direct production of particles having desirable particle sizes. It is also suitable to prepare mixed metal oxide cores by grinding suitable mixed metal oxide feedstocks such as glasses. Glasses are generally prepared by the high temperature fusion of metal oxide precursors to prepare polymeric networks comprising metal oxide subunits. In the context of the invention, mixtures of suitable metal oxide precursors, for example, two or more of silicon dioxide, titanium dioxide, aluminum oxide, and the like, can be prepared and then subjected to high temperature fusion to produce molten glasses. Upon cooling, the glasses typically form as amorphous, noncrystalline masses. The glasses can be reduced to fine particles having particle diameters suitable for use in the invention by any suitable means, such as mechanical grinding.

The particles comprise cores having a surface-treating agent bonded to the surface thereof. Advantageously, the bonded surface-treating agent prevents or reduces the presence of an additional phase between the cores and the polymer precursor or polymer. Typically, the additional phase is air, which forms an air pocket around untreated individual cores when the cores are incorporated into the polymer precursor or polymer. The air pocket, which has an index of refraction of about 1.0, introduces discontinuities in the refractive index of the polymeric composite and increases light scattering, thereby reducing light transmission through the polymeric composite. The bonded surface-treating agent also can reduce aggregation of the cores and optimize distribution of the treated cores in the polymer precursor or polymer. Additionally, the bonded surface-treating agent can have additional functional groups which are reactive with the polymer precursor, such that the surface-treated particles are capable of participating, by means of the functional groups, in the reaction which effects polymerization, and of thereby being incorporated (desirably covalently incorporated) into the polymer. The surface-treating agent can be surface-bound to one or more metal oxides, or the surface-treating agent can be bound to an impurity or an additional component present in the particles.

Desirably, the cores are pre-formed cores. In the context of the invention, pre-formed refers to the formation of the cores prior to combination of the particles with the polymer precursor or polymer to prepare the composite material. In some embodiments, the cores are formed prior to bonding of the surface-treating agent to the cores. For example, when the cores are formed using pyrogenic processes, the cores are typically formed prior to bonding the surface-treating agent to the cores to provide the particles, as the surface-treating agent may be severely degraded or destroyed at the high temperatures employed in pyrogenic processes. In other embodiments, it is suitable to form the cores simultaneously with bonding the surface-treating agent to the cores. For example, when solution processes are used to form the cores, at least one surface-treating agent can be added to the reaction mixture before, during, or after the formation of the cores to bond the surface-treating agent to the cores and to provide the particles directly from the reaction mixture.

In one embodiment, the surface-treating agent is represented by the formula: Q-(CH₂)ₙ—O—CO—C(R⁴)═CH₂ wherein Q is (R¹O)₃Si or XR²R³Si wherein R¹, R², and R³ are independently C₁-C₈ alkyl or C₁-C₈ aryl groups, X is selected from the group consisting of F, Cl, Br, and I, wherein R⁴ is H or methyl, and wherein n is an integer of from 1 to 30. Examples of the surface-treating agent corresponding to the aforementioned formula include but are not limited to [3-((meth)acryloyloxy)propyl]trimethoxysilane, [3-((meth)acryloyloxy)propyl]triethoxysilane, [3-((meth)acryloyloxy)butyl]trimethoxysilane [3-((meth)acryloyloxy)butyl]triethoxysilane, wherein the term (meth) will be understood to represent both methacrylic acid derivatives and acrylic acid derivatives.

In another embodiment, the surface-treating agent is represented by the formula: Q-(CH₂)ₙ-13 O—CO—CR⁴R⁵R⁶ wherein Q is (R¹O)₃Si or XR²R³Si wherein R¹, R², and R³ are independently C₁-C₈ alkyl or C₁-C₈ aryl groups, X is selected from the group consisting of F, Cl, Br, and I, wherein R⁴, R⁵, and R⁶ can be the same or different, and are hydrogen or a C₁-C₈ alkyl, C₁-C₈ aryl, or C₁-C₈ alkylaryl group, and wherein n is an integer of from 1 to 30. Non-limiting examples of the surface-treating agent corresponding to the aforementioned formula are acetoxypropyltrimethoxysilane, acetoxybutyltrimethoxysilane, phenoxypropyltrimethoxysilane, and phenoxypentyltriethoxysilane.

The surface-treating agent can be bonded to the surface of the cores in any suitable manner. For example, the bonding can occur through any suitable bond. Typically the bond that bonds the surface-treating agent to the surface of the cores is selected from the group consisting of an electrostatic interaction, a covalent bond, a coordinative bond, and combinations thereof. Preferably, the bond is a covalent bond.

The bonding of the surface-treating agent to the cores can be performed using any suitable technique, many of which are known in the art. For example U.S. Pat. No. 6,132,861 and references identified therein disclose methods of covalently bonding trialkoxysilanes to metal oxide particles. U.S. Pat. No. 6,344,240 discloses methods of reacting silica particles with organochlorosilanes to covalently bond organosilanes to the surface thereof. [0029] It is well known in the art that particles or aggregates of particles having a surface comprising two or more metal oxides have a refractive index that is between the refractive indices of the individual metal oxides comprising the surface of the particles or aggregates of particles. For example, monodisperse (e.g., nonaggregated) particles consisting of silicon dioxide (SiO₂) can have a refractive index of about 1.4. Corresponding particles consisting of aluminum oxide (Al₂O₃) can have a refractive index of about 1.6, corresponding particles of zirconium oxide (ZrO₂) can have a refractive index of about 2.0, and corresponding particles of titanium dioxide (TiO₂) can have a refractive index of about 2.6. Thus, for example, particles consisting of silicon dioxide and titanium dioxide can have a refractive index between about 1.4 and about 2.6, depending on the relative proportion of silicon dioxide and titanium dioxide in the particles. Although the presence of the bonded surface-treating agent may alter the refractive index of the particles relative to the refractive index of the cores, the refractive index of the particles will primarily depend on the relative ratio(s) of the two or more metal oxides comprising the surface of the particles. Accordingly, the particles can be prepared to have any refractive index that is between the refractive indices of the individual metal oxide components of the particles. For example, particles having a desired refractive index can be prepared by performing preliminary empirical experiments to determine the composition of particles that will have the desired refractive index. Alternatively, in-process monitoring can be performed to adjust the ultimate refractive index of the particles and to arrive at particles having the desired refractive index.

It is well known in the art that the refractive index is a property of a bulk substance. When the bulk substance comprises a plurality of particles, the refractive indices of the individual particles can differ and thus the refractive index of the bulk substance can be considered as an average value of the refractive indices of the individual particles. Statistically, the refractive index of the individual particles can be described by the distribution of refractive indices about the mean, and the distribution can be characterized by the standard deviation of the refractive index of the particles about the mean. If the standard deviation of the refractive index of the particles is large, even though the mean refractive index of the particles (i.e., the refractive index of the bulk substance comprising the particles) is about 2% or less of the refractive index of the polymer precursor or polymer, which is a continuous substance and thus cannot be characterized as having a distribution of refractive indices about a mean, then a composite material prepared by such particles may not exhibit a light transmission of about 85% or more under measurement conditions as described herein. Preferably, the particles have a standard deviation of refractive index about the refractive index of the bulk substance such that the composite material exhibits a light transmission of about 85% or more under measurement conditions as described herein, when the difference between the refractive index of the bulk substance comprising the particles and the polymer precursor or polymer is about 2% or less. It is not necessary to determine the standard deviation of the refractive indices of the particles, but desirably the composite material exhibits a light transmission as described herein.

The cores and the particles can have any suitable average size (e.g., average diameter). The size or the diameter of the core or the particle is defined herein as the diameter of the smallest sphere that can encompass the core or the particle. Typically, the average size of the cores and the particles is about 5 nm or more (e.g., about 10 nm or more, or about 25 nm or more). Preferably, the average size of the cores and the particles is about 1000 μm or less (e.g., about 500 μm or less, or about 250 μm or less, or about 100 μm or less, or about 10 μm or less). More preferably, the average size of the cores and the particles is about 25 nm to about 100 μm (e.g., about 50 nm to about 10 μm). Even more preferably, the average size of the cores and the particles is about 25 nm to about 1000 nm (e.g., about 50 nm to about 500 nm).

The cores and the particles can have any suitable surface area. Generally, the surface area is measured using the BET method. Typically, the cores and the particles have a BET surface area of about 25 m²/g or more (e.g., about 40 m²/g). Preferably, the cores and the particles have a BET surface area of about 500 m²/g or less (e.g., about 400 m²/g or less). In some embodiments, the cores and the particles have a BET surface area of about 25 m²/g to about 125 m²/g (e.g., about 40 m²/g to about 100 m²/g). In other embodiments, the cores and the particles have a BET surface area of about 100 m²/g to about 250 m²/g (e.g., about 125 m²/g to about 200 m²/g). The BET surface area will depend at least in part on the conditions used to prepare the cores and the particles.

The cores and the particles can have any suitable size distribution. Generally, the size distribution is characterized by the standard deviation of the average size of the cores and the particles. Typically, the standard deviation of the average size is about 5% or more of the average size (e.g., about 7.5% or more, or about 10% or more). Preferably, the standard deviation of the average size is about 0.1% or more of the average size (e.g., about 0.5% or more, or about 1% or more). Generally, there is no upper limit to the standard deviation of the average size of the cores and the particles.

The composite material can comprise any suitable amount of the particles. The amount of particles to combine with the polymer precursor or polymer is generally selected to impart a desired coefficient of expansion to be exhibited by the composite material. Typically, the composite material comprises about 1 wt. % or more (e.g., about 5 wt. % or more, or about 10 wt. % or more) of particles. Preferably, the composite material comprises about 80 wt. % or less (e.g., about 70 wt. % or less, or about 60 wt. % or less) of particles. More preferably, the composite material comprises about 10 wt. % to about 50 wt. % of particles (e.g., about 2 wt. % to about 40 wt. %).

The polymer precursor and polymer typically will have refractive indices of about 1.3 to about 1.6 and more particularly about 1.45 to about 1.52. Given a particular polymer precursor or polymer, particles desirably are chosen having a refractive index such that the difference between the refractive index of the polymer precursor or polymer and the refractive index of the particles is about 2% or less of the refractive index of the polymer precursor or polymer (e.g., about 1.5% or less, about 1% or less, about 0.7% or less, or about 0.5% or less, or about 0.3% or less, or about 0.2% or less, or about 0.1% or less). For example, if the polymer precursor or polymer has a refractive index of about 1.500, the particles are selected to have a refractive index of about 1.470 to about 1.530 (e.g., about 1.478 to about 1.523, about 1.485 to about 1.515, about 1.493 to about 1.508, or about 1.496 to about 1.504), provided that the particles have a standard deviation of refractive index about the (mean) refractive index of the particles as a bulk substance, as discussed herein.

Typically, the refractive index of a polymer is about 0.03 higher than the refractive index of the polymer precursor used to prepare the polymer (see, for example, Suzuki et al., J. Dent. Res., 70(5), 883-888 (May 1991)). Thus, the refractive index of the particles can be matched to the refractive index of the polymer precursor, or, for a more accurate match to the polymer after polymerization, the refractive index of the particles can be selected to be about 0.03 higher than the refractive index of the polymer precursor.

The composite material desirably allows a light transmission of about 75% or more (e.g., about 80% or more, or about 85% or more, or about 90% or more, or about 95% or more) of a beam of light directed to the composite material at a specular angle of less than about 5° and having a wavelength of from about 400 nm to about 800 nm, through a thickness of about 2 mm of the composite material. Preferably, the composite material allows a light transmission of about 75% or more (e.g., about 80% or more, or about 85% or more, or about 90% or more, or about 95% or more) of a beam of light directed to the composite material at a specular angle of less than about 5° and having a wavelength of about 400 nm. The light transmission can be measured with a commercially available transmissometer, such as are available from Graham Optical Systems of Chatsworth, Calif. Advantageously, when the composite material comprises a polymer, the composite material is highly transparent to at least visible light and is useful in a variety of applications requiring a high degree of light transmission through a material having a low coefficient of thermal expansion.

The invention further provides a process for preparing the composite material. The process comprises (i) providing a polymer precursor or polymer, wherein the polymer precursor or polymer has a first refractive index, (ii) providing particles comprising (1) cores having a surface comprising at least two oxides selected from the group consisting of silicon oxide, titanium oxide, aluminum oxide, cerium oxide, tantalum oxide, tin oxide, cerium oxide, and hafnium oxide, wherein the cores comprise aggregates of primary particles, and (2) a surface-treating agent bonded to the surface of the cores, wherein the particles have a second refractive index, and wherein the difference between the first refractive index and the second refractive index is about 2% or less of the first refractive index, and (iii) combining the polymer precursor with the particles. The polymer precursor, the polymer, and the particles are as described herein.

The particles can be incorporated into the polymer precursor or polymer by any suitable method. One suitable method is to provide the polymer precursor or polymer in the form of a solution in any suitable solvent that is compatible with the polymer precursor or polymer. The particles are then incorporated into the solution using any suitable method that incorporates the particles into the solution to provide a uniform dispersion of particles in the solution. Another suitable method is to pre-disperse the particles in a solvent that is compatible with the polymer precursor or polymer. The pre-dispersion is then incorporated into the polymer precursor or polymer, wherein the polymer precursor or polymer optionally comprises a suitable solvent. Examples of suitable solvents include aliphatic alcohols such as ethanol or butanol, acetone, ethylene glycol, diethylene glycol, and polyglycols. The particles also can be directly dispersed in the polymer precursor or polymer. A highly concentrated dispersion of the particles in the polymer precursor or polymer can also be prepared, which dispersion (commonly referred to as a masterbatch) can then be dispersed in additional polymer precursor or polymer to provide a desired amount of particles in the polymer precursor or polymer. Preferably, the particles are dispersed in the polymer precursor or polymer without the use of a solvent.

When a polymer precursor is used in the preparation of the composite material, the mixture of polymer precursor and particles can be polymerized to provide a polymerized composite material. The selection of appropriate polymerization method for any particular polymer precursor will be readily apparent to one of ordinary skill in the art. For example, (meth)acrylates can be polymerized by free radical or cationic mechanisms. Polycarbonates can be prepared by introduction of the phosgene equivalent into a mixture comprising an organic diol. Polyurethanes can be prepared under the influence of acid or base catalysis and by heating of the polymer precursor.

After polymerization, the polymerized composite material of the invention can be further processed to provide desired end-products. Alternatively, the inventive process can be practiced by conducting the polymerization in a mold to provide a transparent molding having a desired shape or contour. Examples of useful end-products include but are not limited to windows, lenses, optical isolators, waveguides, optical connectors, optical display devices, and the like. Other useful applications of the invention will be readily apparent to the ordinarily skilled artisan.

### EXAMPLE

This following example further illustrates the invention but, of course, should not be construed as in any way limiting its scope.

A titania-silica glass (CLE®, Corning Advanced Optics, Canton, N.Y.), comprising titanium dioxide and silicon dioxide and having a published refractive index of 1.4828 at a wavelength of 656 nm and a temperature of 25° C., was mechanically crushed to provide fine particles having a mean particle size of about 10 μm. The particles were surface-treated by a process comprising (a) mixing 10 g of the particles with 50 g of water and 50 g of methanol, (b) adding about 0.3 g of 3-(methacryloyloxy)propyltrimethoxysilane and then 50 g of methanol, (c) refluxing the mixture for 4 h, (d) isolating the surface-treated particles by filtration, and (e) drying the particles.

A sample of the treated particles was mixed with a refractive index liquid comprising terphenyl (i.e., a polymer comprising phenyl repeating units) and hydrogenated terphenyl (Cargille Laboratories, Cedar Grove, N.J.) having a refractive index of 1.486 at a wavelength of 589 nm and a temperature of 25° C. to provide a composite material comprising the surface-treated mixed metal oxide particles. The difference between the refractive index of the surface-treated mixed metal oxide particles and the refractive index of the refractive index liquid was 0.20% of the refractive index of the refractive index liquid.

The light transmission exhibited through a 2 mm thickness of the composite material as measured by a spectrophotometer at a wavelength of 589 nm and a temperature of 25° C. was 90%.

The results of this example demonstrate the feasibility of preparing a desirable refractive index-matched composite material in accordance with the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A composite material comprising:
(a) a polymer precursor or polymer, wherein the polymer precursor or polymer has a first refractive index, and
(b) particles comprising (1) cores having a surface comprising at least two metal oxides selected from the group consisting of silicon oxide, titanium oxide, aluminum oxide, cerium oxide, tantalum oxide, tin oxide, cesium oxide, and hafnium oxide, wherein the cores comprise aggregates of primary particles, and (2) a surface-treating agent bonded to the surface of the cores, wherein the particles have a second refractive index,
wherein the difference between the first refractive index and the second refractive index is about 2% or less of the first refractive index.

2. The composite material of claim 1, wherein the polymer precursor or polymer comprises monomeric units selected from the group consisting of acrylate monomers, methacrylate monomers, silicone monomers, a combination of an organic diol and a phosgene equivalent, and a combination of an organic diol and a diisocyanate.

3. The composite material of claim 1, wherein the cores are prepared by a vapor-phase process.

4. The composite material of claim 1, wherein the cores are prepared by a solution process.

5. The composite material of claim 1, wherein the composite material allows a light transmission of about 85% or more of a beam of light directed to the composite material at a specular angle of less than about 5° and having a wavelength of about 400 nm, through a thickness of about 2 mm of the composite material.

6. The composite material of claim 1, wherein the cores comprise at least two metal oxides selected from the group consisting of silicon oxide, titanium oxide, aluminum oxide, cerium oxide, tantalum oxide, and tin oxide.

7. The composite material of claim 6, wherein the polymer precursor or polymer comprises monomeric units selected from the group consisting of acrylate monomers, methacrylate monomers, silicone monomers, a combination of an organic diol and a phosgene equivalent, and a combination of an organic diol and a diisocyanate.

8. The composite material of claim 6, wherein the cores are prepared by a vapor-phase process.

9. The composite material of claim 6, wherein the cores are prepared by a solution process.

10. The composite material of claim 9, wherein the cores are prepared by a solution process in the presence of the surface-treating agent.

11. The composite material of claim 6, wherein the surface-treating agent is covalently bonded to the surface of the cores.

12. The composite material of claim 6, wherein the surface-treating agent is a compound of the formula: Q-(CH₂)ₙ—O—CO—C(R⁴)═CH₂ wherein Q is (R¹O)₃Si or XR²R³Si wherein R¹, R², and R³ are independently C₁-C₈ alkyl or aryl groups, X is selected from the group consisting of F, Cl, Br, and I, wherein R⁴ is H or methyl, and wherein n is an integer of from 1 to 30.

13. The composite material of claim 6, wherein the surface-treating agent is a compound of the formula: Q-(CH₂)ₙ—O—CO—CR⁴R⁵R⁶ wherein Q is (R¹O)₃Si or XR²R³Si wherein R¹, R², and R³ are independently C₁-C₈ alkyl or aryl groups, X is selected from the group consisting of F, Cl, Br, and I, wherein R⁴, R⁵, and R⁶ can be the same or different, and are hydrogen or a C₁-C₈ alkyl, aryl, or alkylaryl group, and wherein n is an integer of from 1 to 30.

14. The composite material of claim 6, wherein the composite material allows a light transmission of about 85% or more of a beam of light directed to the composite material at a specular angle of less than about 5° and having a wavelength of about 400 nm, through a thickness of about 2 mm of the composite material.

15. The composite material of claim 6, wherein the composite material comprises a polymer precursor.

16. The composite material of claim 6, wherein the composite material comprises a polymer.

17. A process for preparing a composite material, which process comprises:
(i) providing a polymer precursor or polymer, wherein the polymer precursor or polymer has a first refractive index,
(ii) providing particles comprising (1) cores having a surface comprising at least two metal oxides selected from the group consisting of silicon oxide, titanium oxide, aluminum oxide, cerium oxide, tantalum oxide, tin oxide, cesium oxide, and hafnium oxide, wherein the cores comprise aggregates of primary particles, and (2) a surface-treating agent bonded to the surface of the cores, wherein the particles have a second refractive index, and wherein the difference between the first refractive index and the second refractive index is about 2% or less of the first refractive index, and
(iii) combining the polymer precursor or polymer with the particles to provide a composite material.

18. The process of claim 17, wherein the polymer precursor or polymer comprises monomeric units selected from the group consisting of acrylate monomers, methacrylate monomers, silicone monomers, a combination of an organic diol and a phosgene equivalent, and a combination of an organic diol and a diisocyanate.

19. The process of claim 17, wherein the cores are prepared by a vapor-phase process.

20. The process of claim 17, wherein the cores are prepared by a solution process.

21. The process of claim 17, wherein the composite material allows a light transmission of about 85% or more of a beam of light directed to the composite material at a specular angle of less than about 5° and having a wavelength of about 400 nm, through a thickness of about 2 mm of the composite material.

22. The process of claim 17, wherein step (i) comprises providing a polymer precursor, and further comprising a step (iv) of polymerizing the polymer precursor to provide a polymerized composite material.

23. The process of claim 17, wherein the polymerized composite material allows a light transmission of about 85% or more of a beam of light directed to the composite material at a specular angle of less than about 5° and having a wavelength of about 400 nm, through a thickness of about 2 mm of the polymerized composite material.

24. The process of claim 17, wherein the cores comprise at least two metal oxides selected from the group consisting of silicon oxide, titanium oxide, aluminum oxide, cerium oxide, tantalum oxide, and tin oxide.

25. The process of claim 24, wherein the polymer precursor or polymer comprises monomeric units selected from the group consisting of acrylate monomers, methacrylate monomers, silicone monomers, a combination of an organic diol and a phosgene equivalent, and a combination of an organic diol and a diisocyanate.

26. The process of claim 24, wherein the cores are prepared by a vapor-phase process.

27. The process of claim 24, wherein the cores are prepared by a solution process.

28. The process of claim 27, wherein the cores are prepared by a solution process in the presence of the surface-treating agent.

29. The composite material of claim 24, wherein the surface-treating agent is covalently bonded to the surface of the cores.

30. The process of claim 24, wherein the surface-treating agent is a compound of the formula: Q-(CH₂)ₙ—O—CO—C(R⁴)═CH₂ wherein Q is (R¹O)₃Si or XR²R³Si wherein R¹, R², and R³ are independently C₁-C₈ alkyl or aryl groups, X is selected from the group consisting of F, Cl, Br, and I, wherein R⁴ is H or methyl, and wherein n is an integer of from 1 to 30.

31. The process of claim 24, wherein the surface-treating agent is a compound of the formula: Q-(CH₂)ₙ—O—CO—CR⁴R⁵R⁶ wherein Q is (R¹O)₃Si or XR²R³Si wherein R¹, R², and R³ are independently C₁-C₈ alkyl or aryl groups, X is selected from the group consisting of F, Cl, Br, and I, wherein R⁴, R⁵, and R⁶ can be the same or different, and are hydrogen or a C₁-C₈ alkyl, aryl, or alkylaryl group, and wherein n is an integer of from 1 to 30.

32. The process of claim 24, wherein the composite material allows a light transmission of about 85% or more of a beam of light directed to the composite material at a specular angle of less than about 5° and having a wavelength of about 400 nm, through a thickness of about 2 mm of the composite material.

33. The process of claim 24, wherein step (i) comprises providing a polymer precursor, and further comprising a step (iv) of polymerizing the polymer precursor to provide a polymerized composite material.

34. The process of claim 24, wherein the polymerized composite material allows a light transmission of about 85% or more of a beam of light directed to the composite material at a specular angle of less than about 5° and having a wavelength of about 400 nm, through a thickness of about 2 mm of the polymerized composite material.
